(19) United States
(12) Patent Application Publication
(10) Pub. No.: US 2009/0273438 A1
(43) Pub. Date: Nov. 5, 2009

(54) Remote monitoring, interrogation and control apparatus for stationary and mobile systems

(75) Inventors: Michel F. Sultan, Troy, MI (US); Dale L. Partin, Ray Township, MI (US); Laci J. Jalics, Ray, MI (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 12/150,872

(22) Filed: May 1, 2008

(51) Int. Cl. G05B 19/00; G08C 19/00

(52) U.S. Cl. 340/5.7; 340/5.1; 340/5.81

(57) ABSTRACT

A wireless control apparatus includes a function control device adapted to control a function and a nomadic device. The nomadic device and the function control device communicate by a long-range communication network to control functions on the function control device in response to signals from the nomadic device. The nomadic device and the function control device can also communicate by a mid-range communication network. A portable fob transmits signals to the function control device and/or the nomadic device for controlling functions.

### BACKGROUND

The present invention relates, in general, to remote wireless control and entry systems for controlling vehicle, home, garage door, functions.

Consumers on the go oftentimes wish to monitor, interrogate, and/or control remote stationary or mobile systems from anywhere, at any time, even when they are away from home or the office. There is a variety of reasons for this desire, including the need to check on the status of a home security system or the battery of a car parked at the airport, to monitor environments where a child or an elderly parent is being cared for, to view the interior or exterior of their vehicle to insure that it is not being tampered with, to start their vehicle, to cool down or heat up the vehicle interior, to unlock the doors before reaching the vehicle, to prepare coffee before arriving at home, to open a garage door, to check the diagnostic status of the vehicle before a trip, etc.

In particular, consumers owning a vehicle typically carry a key fob to perform some of the vehicle-related functions described above; but these functions are normally restricted to functions that require only short range, one-way communication to the vehicle. These functions typically include the remote access of the vehicle functions, such as unlocking or locking the vehicle doors, unlocking the rear hatch or trunk, remotely starting the vehicle engine, activating the vehicle horn and lights, etc. In order to broaden the range of applications of such key fobs, recent trends have been to add greater range, to give them bi-directional capability, and to add a display to indicate vehicle information. Since these control functions require more energy and power, the current trend is to make the fob battery rechargeable. These fobs also tend to be larger, heavier and more expensive.

It would be desirable to provide a communication device which eliminates the need for a consumer to carry yet another nomadic device which could enable the broadcast range of both stationary and mobile control applications described above. It would also be desirable to provide a wireless communication device which eliminates the need to augment the capabilities and tax the size and energy requirements of vehicle remote keyless entry fobs. It would also be desirable to provide a remote communication control system which utilizes as much as possible the commercially available communication and infotainment devices that most consumers typically carry, including cell phones, wireless PDAs, etc. It would also be desirable to use the inherent capability of these communication and infotainment devices without any modification of the hardware and software of such devices and without the need to engage cell phone manufacturers or service providers in the business relationship beyond the usual cost of using their normal services.

It would also be desirable to provide a communication control means which increases the range of applications of hand-held communication or infotainment devices by making such devices applicable to a broad range of remote monitoring, interrogation, and control functions. It would also be desirable to enable consumers to carry and use only a single long-range device which has the ability to transmit and receive information in the form of voice, text, pictures, or data while optionally employing a relatively short range fob for routine functions, such as unlocking doors, satisfying a vehicle immobilizer function, etc.

### SUMMARY

A remote monitoring, interrogation and control apparatus for stationary and mobile systems uses a function control device adapted to control functions and a nomadic device adapted for transmitting function signals. Communication means that are carried by the nomadic device and the function control device are divided for transferring communication signals over one of a long-range communication network or a mid-range communication network.

In addition, a portable fob transmits a signal relating to a control function directly to the function control device.

The remote monitoring, interrogation and control apparatus can also be integrated with a building and can be typically associated with a building entrance or door. An input device disposed at the entrance or door of the building is coupled to the function control device for automatically placing a telephone call to the nomadic device when an input device, such a doorbell, an intercom switch is depressed or motion is detected at the door. Another input device, such as a camera, can take a still picture or a video of the entrance area. A function control device forwards the picture or video, as well as messages to the nomadic device through a communication network which can include a cellular telephone, a landline telephone, a data telephone, a wireless telephone, a satellite telephone and an Internet telephone. The function control device, in response to user commands through the nomadic device and communication network, can send messages to an intercom at the door as well as controlling the end locking, opening, closing and locking states of the door.

### BRIEF DESCRIPTION OF THE DRAWING

The various features, advantages and other uses of the remote monitoring, interrogation and control apparatus will become more apparent by referring to the following detailed description and drawing in which:

FIG. 1 is a pictorial representation of one aspect of a remote monitoring, interrogation and control apparatus;

FIG. 2 is a pictorial representation of another aspect of a remote monitoring, interrogation and control apparatus; and

FIG. 3 is a pictorial representation of another aspect of a remote monitoring, interrogation and control apparatus.

### DETAILED DESCRIPTION

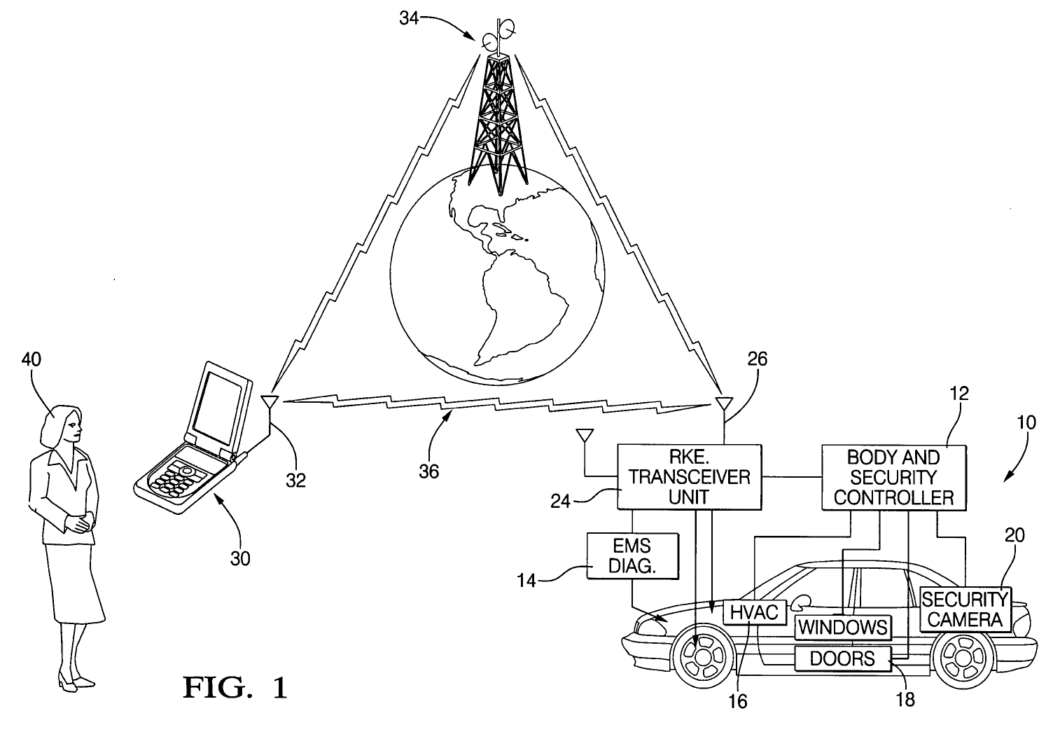

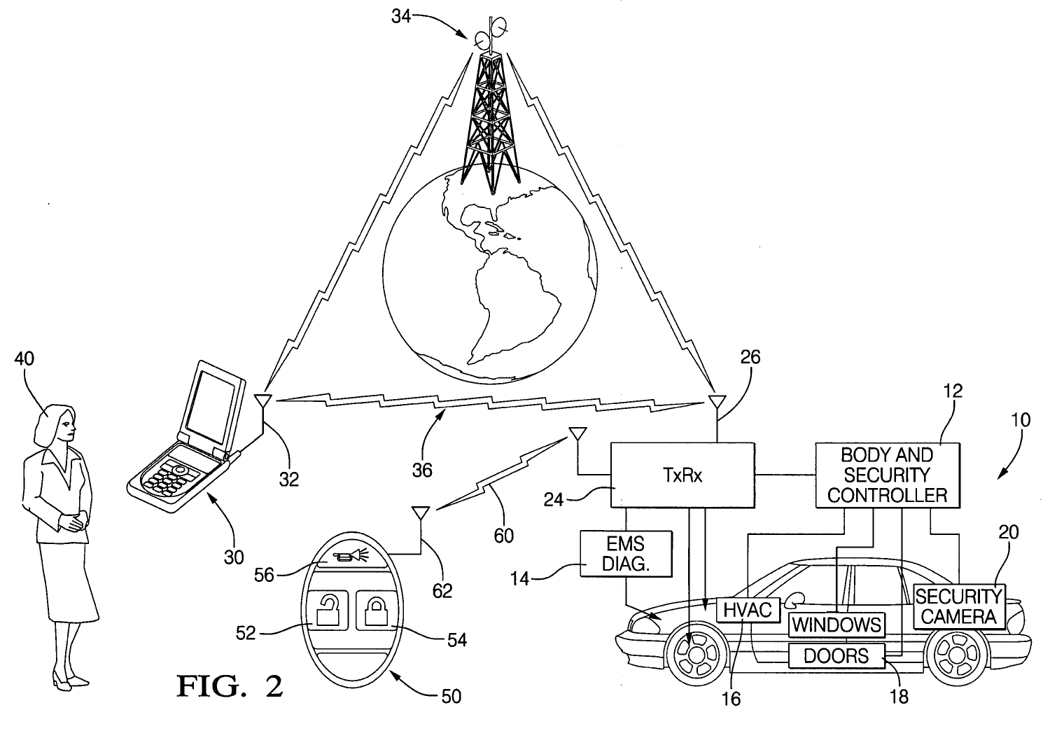

Referring now to FIGS. 1-2, for illustrative purposes and only by way of example, the stationary or mobile system controlled by the apparatus described hereafter, will be a vehicle that the user, typically the driver, wishes to monitor, interrogate, or to control various vehicle functions. The vehicle 10 will be used as an illustration. It is understood that the control apparatus can be used to control other stationary or mobile systems, such as opening and closing a garage door, controlling various functions within a home, such as turning on and off various lights, starting a coffee maker, raising or lowering the home temperature, etc. A building may refer to a home, apartment, garage, or office building.

By way of example only, the vehicle 10 includes a body and security controller 12 which is coupled to various vehicle control functions or equipment, such as an engine maintenance diagnostic system 14, a vehicle HVAC system 16, vehicle doors and hatch actuators 18, a security camera or door/window tampering detection system 20, etc.

A base station 24, hereafter referred to as a remote keyless entry system or transceiver unit, (RKE), includes a transceiver having a receiver portion for receiving wireless electronic signals from a remote transmitter and a transmitter for transmitting wireless signals through an antenna 26 to remote, mobile devices. The RKE 24 is directly or indirectly electrically coupled to the body vehicle and security controller 12. A processor or controller in the RKE 24 is coupled to the receiver of the RKE 24 to decode wireless control signals from remote devices so that the requested vehicle control function can be determined and executed by the body and security controller 20.

The transceiver unit in the RKE 24, in a first aspect, can have its own cellular number or IP address.

As shown in FIG. 1, a handheld nomadic device that the vehicle owner typically carries is used to communicate with the vehicle RKE 24. The nomadic device 30 may be any nomadic device which provides voice, a display of pictures, video or text, or alphanumeric inputs, via discrete depressible input members, a touch sensitive display screen, etc. For example, the nomadic device may a cellular telephone, a PDA, a laptop computer, etc.

The nomadic device 30 is coupled to a wireless infrastructure, such as a cellular network denoted generally by reference number 34, for long range or global communication and/or a medium range WiMax or WiFi Mesh Network 36. Communication between the nomadic device 30 and the vehicle RKE 24 may be initiated by the user or, in some cases, by the RKE 24.

The user 40 has different options to initiate a communication with the vehicle RKE 24. For example, the vehicle's cell phone number can be programmed into a personal cell phone 30. The user would push the appropriate speed dial button on the cell phone 30 to call the vehicle RKE 24, just as the user would do to call a friend. When the call is completed, the vehicle's cell phone answers with a message asking for authentication. For example, the message may be a recorded voice or text message that says “PIN number please.” The user then uses the handheld cell phone 30 keyboard or the screen of the PDA or cell phone to enter the vehicle PIN number, which may be four alphanumeric digits or characters, or the PIN may be spoken and processed by a speech recognition system in the vehicle RKE 24 to decipher the PIN number. This authenticates the caller.

An alternate approach would be to program the cell phone 30 in a conventional way to transmit the PIN code automatically or through another speed dial number when the call is completed. Unauthorized callers could be dealt with in a number of ways, such as by requiring a waiting period of perhaps one minute after one or two incorrect pin numbers are entered before another attempt can be made. Alternately, after the entry of a number of incorrect PIN numbers, the vehicle RKE 24 could terminate the call and place a call to the owner's phone number to give a prerecorded voice or text message indicating that incorrect PIN numbers have been attempted to be entered into the vehicle RKE 24. Another authentication alternative is that a “caller ID” function could be used to identify calls that come from a prearranged, preapproved list of phone numbers. The numbers would be stored in the memory of the RKE 24. Calls from this list could automatically be assured to be authenticated. Calls from other phone numbers would either be excluded or would require entry of a PIN number. An alternative to a PIN number would be a prerecorded phrase that would function as a password, such as “let's meet at the coffee shop.” Other authentication schemes are possible to prevent unauthorized users from accessing the vehicle RKE 24.

Authentication from a Web-enabled device could include a user name and password challenge/response questions, and even allowing connections from a list of known or preauthorized devices or IP addresses.

Communications with the vehicle 10 may be by text or voice, or by an Internet Website hosted by the transceiver of the RKE 24 may be accessed by the handheld nomadic device 30. The nomadic device 30 can download the vehicle's webpage. Vehicle status can be viewed, and the user can scroll or point to specific items on the display and click on them for more information or to issue commands.

One aspect of the vehicle's status is that diagnostic trouble codes exist in most every subsystem on today's vehicles. These diagnostic trouble codes are very helpful in identifying current vehicle performance issues and also imminent or worn out components. As an example, the vehicle owner could request a diagnostic/prognostic report that would detail current issues as well as upcoming needed maintenance. These options and their order can be user customizable. Choosing voice communications will still allow the user to enter choices by pressing a numeric key on the keyboard of the nomadic device 30, since the user may sometimes be in a noisy environment in which it is difficult for a speech interpreter in the RKE 24 to correctly interpret the user's commands.

After authentication, the vehicle's RKE 24 sends a short status report, such as “everything is okay” or “vehicle alarms are sounding.” The RKE 24 then sends a menu of choices, via voice message. For example, a first voice menu could say “to check for vehicle status, press or say one”, “to start the vehicle, press or say two”, or “to change the vehicle temperature, press or say three”, etc. The user could immediately give a response if he or she knows the menu item after using it a few times. Such choices would call up second level menus, such as “choice one above” which would then ask the user, for example, “to check for vehicle problems, press or say one”, etc., “to check security cameras, press or say two.”

In the second menu, if “one” is entered, the user could, for example, hear “all systems are okay, for more information press or say star” or “the pressure in the right front tire is eight pounds per square inch, check tire”, or “the vehicle alarms are sounding, and intrusion may be underway, a picture of the vehicle interior will be transmitted momentarily, for more information press or say star” or “alcohol vapor has been detected, for more information press or say star.”

If the vehicle has a GPS sensor in it, the GPS position of the vehicle, when it is parked, could be recorded. If the owner later wanted to locate the vehicle, he or she could then select a menu item that would download a map showing the area around the vehicle and an icon, such as a red “X” marking the location of the vehicle on the map. The map could show the position of buildings, roads, rivers, lakes, etc., to assist the user in orientating the map correctly and to find the location of the vehicle.

In each of the above examples, the user initiated a communication or call to the vehicle RKE 24. The vehicle RKE 24 could also call the owner to notify him or her of a problem. The list of problems that could cause such a call to the user can be user-selectable. For example, a high vehicle interior temperature, such as 105° F., would typically not be a problem that the user wants to receive a call about. The activation of vehicle alarms, a flat tire, low vehicle battery, etc., would be situations that the user typically wants to know about immediately. The primary phone number of the nomadic device 30 is called by the RKE 24 and the phone is answered, authentication can be presumed or a PIN number can be requested. If there is no answer, a voice message can be left on the nomadic device 30. In this case, if there is a secondary number to call, the RKE 24 would then call that secondary number next. Ultimately, wireless data connection, an e-mail, text message, instant message, or page can be sent to the user.

Although the above description of the use of the nomadic device 30 has been described as being a cell phone or wireless PDA to communicate with the vehicle RKE 24 when the distance to the vehicle is too great to use a fob, other devices that can place a telephone call, such as a wired telephone or personal computer connected to the Internet, can also be used to communicate with the vehicle 10.

In addition to long-range communication between the nomadic device 30 and the vehicle RKE 24 by the global network 34, a mid-range communication can also be implemented by WiMax or WiFi network 36. The same functions described above can be employed in the RKE 24 and the nomadic device 30 to establish a unidirectional and/or bidirectional communication therebetween using the network 36.

Referring now to FIG. 2, another aspect of the apparatus is depicted. In addition to the nomadic device 30, it may be desirable to use a basic or minimal function wireless key fob 50 which has a limited number of vehicle control function inputs, such as locking and unlocking the vehicle doors 52 and 54, and to sound the vehicle horn and/or lights in a panic or emergency situation via input button or member 56. The requirements for the basic fob 50 are minimal and include short-range, unidirectional communication and a small capacity battery. Power and energy requirements on the fob battery are generally minimal so that in most cases it is not necessary to have a battery recharging capability, although such can be provided for the fob 50.

The fob 50 wirelessly communicates by Rf (radio frequency) communication 60 through a fob antenna 62 and an Rf antenna 64 on the RKE 24. This relatively short range communication can be anywhere from one to one hundred meters, for example only.

The fob 50 would be useful in areas where there is no cellular phone coverage which prohibits the use of the nomadic device 30, or as a back up in case the user forgets to carry the nomadic device 30. The fob 50 may optionally employ a passive keyless entry device, such as a RFID. In this mode, the person with the RFID device in the fob 50 may only need to touch a door handle or door lock in order to unlock or lock the vehicle. The RFID device may be sensed after the person carrying it enters the vehicle which has a vehicle immobilizer system. In this mode, the vehicle may be started and operated by pushing a start button in the vehicle. Alternately, the fob may function as a standard active remote keyless entry device using buttons 52, 54, and 56 on the fob that are pushed to transmit a code that activates a vehicle function.

The fob 50 may include keyless and immobilizer systems since such systems require additional hardware that is not normally included in the nomadic devices 30. The vehicle owner may rely on the basic key fob 50 most of the time and would use the nomadic device 30 for specialized functions only or for long-range communication when the user 40 is located a considerable distance away from the vehicle 10.

Although the aspects of the apparatus described above do not require hardware or software modifications of the nomadic device 30, this does not preclude the option of cooperating with a cellular telephone or wireless communication company. In this case, it becomes possible to incorporate additional hardware into the nomadic device 30, including keyless entry, mobilizer, and vehicle locator functions. Furthermore, new software that improves the user 40/nomadic device 30 interface may be downloaded directly into the nomadic device 30.

For a vehicle finder application, if the nomadic device 30 includes a GPS sensor, the nomadic device 30 could transmit the location of the user 40 to the vehicle 10. When the user 40 selects a menu item that sends a match showing the vehicle position back to the nomadic device 30, the display on the nomadic device 30 could also shown the users 40 position on the map with an icon. The heading of the vehicle, such as northwest, east, etc., could also be indicated as well as the distance between the user 40 and the vehicle 10. Also, if the cell phone contains an electronic compass, then the orientation of the cell phone relative to the earth's magnetic field could be shown and the direction to the vehicle could also be shown by an arrow on the display of the nomadic device 30.

The RKE 24 may communicate with the nomadic device 30 in a number of different ways, in addition to the modes already described. For example, the RKE 24 may be able to send a picture of the vehicle 10 to the user's default phone number (“press or say one”) or to a different phone number (“press or say two”) followed by the entry of the phone number. Options also include turning on a vehicle microphone and listening to sounds in the vehicle, to be able to carry on a conversation with someone in the vehicle, or to turn off the vehicle alarm system. Entering any of the above options, except the last one, could result in a message being broadcast in the vehicle such as “this vehicle is now being monitored visually or audibly.” A few seconds pause could be required before a picture is taken by a security camera 20 in the vehicle 10. Additional menu items in the case of a video or pictures being sent include receiving pictures from different cameras if they are present in the vehicle 10, allowing the user to steer a movable camera in the vehicle 10 to take pictures of the vehicle in different directions or receiving video from a camera in the vehicle. Also, the interior and/or exterior lights could be turned on. Infrared light sources, such as infrared light emitting diodes, could be used for illumination whenever the vehicle cameras are active. The video or pictures could include a portion of the interior and/or exterior of the vehicle and the vehicle's surroundings.

A “picture” as used in this invention encompasses video as well as single or multiple pictures, including pictures taken from more than one camera.

Another possible menu choice on the nomadic device 30 may bring a third party, besides the vehicle owner and the vehicle communication network provider, into communications. The third party could involve a service in which the person could obtain help for a variety of events, such as directions, service, emergencies, etc.

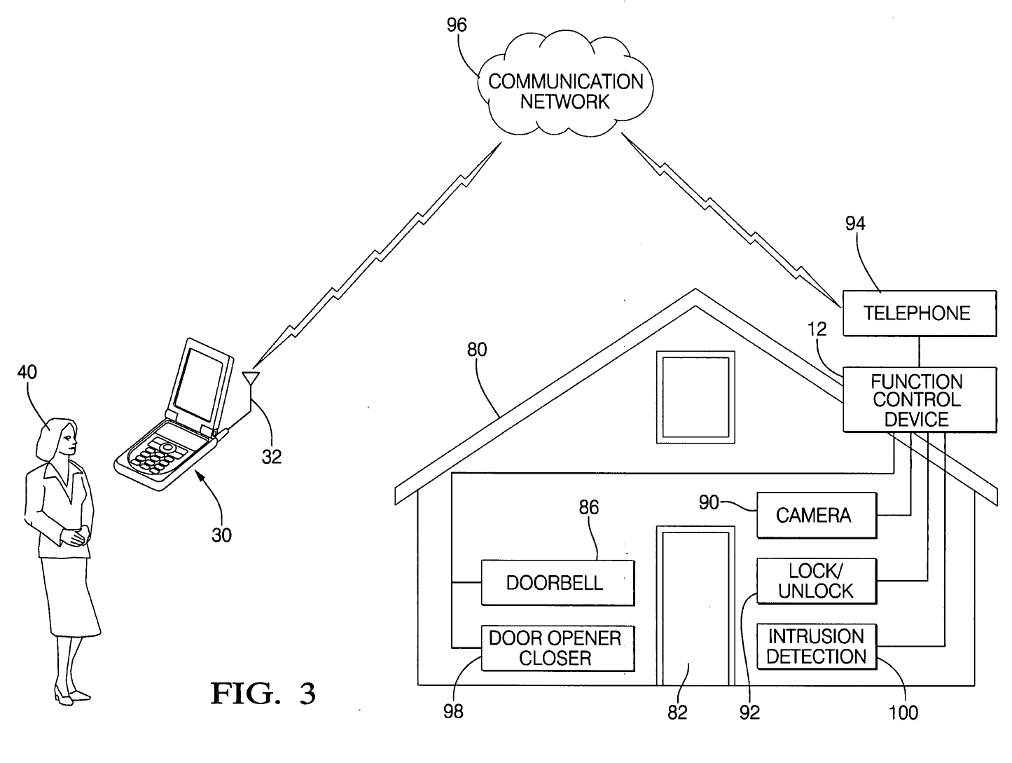

The apparatus is not restricted to monitoring, interrogating or controlling only remote vehicle systems. The apparatus may be extended to stationary systems, as well, such as garage doors and a variety of home-related applications, such as front door locks, a heating system, a ventilation and an air conditioning system, lighting, and security systems with cameras or other sensors. For example, if someone approaches a door 82 of a house 80, see FIG. 3, and activates an input device 84, such as ringing the doorbell 85 or depressing an intercom 88 push button, they could hear a recorded message “one moment please” through the intercom or a speaker 88. Meanwhile, a call or an instant message or an e-mail is placed to the owner's nomadic device 30 is sent. The owner receives a message such as “someone is at the front, rear, side or garage door of your house. Press or say one to speak with the person, press or say two to see a picture of the person, press or say three to do both, or press star anytime to unlock the door.” If the owner or user presses the star key, then optionally a menu could be displayed on the nomadic device 30 which would seek confirmation by asking the person to again press the star key or to input a PIN code with the signal being blocked so that the person at the door could not hear the automated message to the user or to hear the PIN code being input to the nomadic device 30. This could be useful in admitting a repair or service person, a friend who arrives at the home before the owner does, a child, etc.

In-house monitoring systems can include multiple cameras or web cams 90 so that the user could monitor the person who entered the house 80. This function would require the use of a door lock 92 that could be remotely unlocked and locked, one or more appropriately placed cameras 90 and microphones, or an intercom 88 or a microphone and speaker next to each door 82, a telephone 94 integrated with the house and equipment similar to the function control device or RKE 12 shown in FIG. 1. In this case, the function control device or RKE 12 could use a link through a communication network 96 such as a conventional landline telephone connection 94, an Internet connection, or wireless telephone connection via a cellular telephone or satellite network, to the nomadic device 30. A traditional landline telephone would not be favored for sending pictures or videos due to its narrow bandwidth.

Various modifications or additions could be made to this system including a sensor that detects if someone is knocking on the door 82 instead of ringing a doorbell, a sensor that detects someone approaching the door, a system that detects if someone is approaching a window or other part of the home, etc. The telephone integrated 94 with the building can be automatically muted when instructions are being issued from the telephone so that the person at the entrance or door 82 cannot hear them. Additionally, an instruction to the function control device 12 will only be accepted while the telephone 29 is at least one of off, muted, or temporarily deactivated.

Another input device associated with the building entrance or door 82 is an automated door opener and closer 98 which is coupled to the door 82 for opening the door 82, when the door 82 is unlocked, or closing the door 82 from an open position. Control signals to the door opener and closer 98 are generated by the function control device 12 in response to commands from the user of the nomadic device 30.

The function control device 12 can also be operative to control a camera, such as camera 90, positioned at the door or entrance 82 of the building 80 to take a picture of a person at the door 82 and to transmit the picture or video through the communication network 96 to the nomadic device 30.

In addition, another input device can be an intrusion detection system 100 associated with the door 82 as well as other entry points to the building 80, such as other doors, windows, etc.

In response to an alarm signal from the intrusion detection system 100 or any of the intrusion detection sensors, the function control device 12 will initiate the various alarm states, such as an alarm voice message to the intercom 88, an alarm signal, a data message, and/or a pictorial representation of the entrance area surrounding the door 82 through the communication network 96 to the user of the nomadic device 30.

What is claimed is:

1. An apparatus for communicating signals between a wireless nomadic device and a wireless function control device integrated with a vehicle, the apparatus comprising:
the nomadic device being a commercially available nomadic device with substantially unchanged original software and hardware operative to communicate with the function control device.

2. The apparatus of claim 1 wherein the nomadic device is capable of communicating with the vehicle through a long range cellular communication network.

3. The apparatus of claim 1 wherein the nomadic device is capable of communicating with the vehicle through a mid-range communication network which is at least one of a Wi-Fi and a WiMax communication network.

4. The apparatus of claim 1 wherein the nomadic device uses at least one voice and tone-based inputs to communicate with the function control device.

5. The apparatus of claim 1 wherein the nomadic device is one of a cellular phone, a PDA, a laptop computer, a desktop computer, and a landline telephone.

6. The apparatus of claim 1 wherein the vehicle has an intrusion detection apparatus which initiates one of an alarm voice, a data message and a pictorial representation of the vehicle to the nomadic device if an intrusion is detected.

7. The apparatus of claim 1 wherein the vehicle has a diagnostic system for detecting vehicle fault conditions which initiates at least one of an alarm voice message and a data message to the nomadic device if a fault condition is detected.

8. The apparatus of claim 1 wherein the nomadic device is operative to request and view a picture of the vehicle.

9. The apparatus of claim 1 further comprising authentication means for establishing authentication of at least one of a user of the nomadic device and a nomadic device before a command to the function control device is acted on.

10. The apparatus of claim 1 further comprising:
a portable fob having a transmitter for transmitting a signal relating to a control function; and
the function control device having a receiver configured for receiving the signal transmitted by the portable fob for controlling at least one control function in response to activation of the fob.

11. The apparatus of claim 10 wherein:
the transmitter of the fob and the receiver of the function control device are configured for radio frequency communication.

12. The apparatus of claim 1 further comprising:
the function control device having a transceiver for transmitting and receiving communication signals with a nomadic device, the transceiver having an internet protocol address.

13. An apparatus for communicating signals between a nomadic device and a function control device integrated with a building, the apparatus comprising:
an input device at an entrance of the building, the input device capable of automatically placing a telephone call to the nomadic device;
a camera for sending a picture of an area encompassing the building entrance to the nomadic device when the telephone call is placed; and
means for communicating an instruction from the nomadic device to the function control device to control at least one of unlock, open, close and lock status of a door at the entrance to the building.

14. The apparatus of claim 13 wherein:
the nomadic device being a commercially available nomadic device with substantially unchanged original software and hardware operative to communicate with the function control device.

15. The apparatus of claim 13 wherein the nomadic device is capable of communicating with the function control device through at least one of a cellular telephone, a land line telephone, a data telephone, a wireless telephone, a satellite telephone and an Internet telephone.

16. The apparatus of claim 13 wherein the nomadic device uses at least one of voice inputs and tone-based inputs to communicate with the function control device.

17. The apparatus of claim 13 wherein the nomadic device is one of a cellular phone, a PDA, a laptop computer, a desktop computer, and a standard land-line telephone.

18. The apparatus of claim 13 wherein the building has an intrusion detection apparatus which initiates one of an alarm voice, a data message and a pictorial representation of the entrance area to the nomadic device if an intrusion attempt is detected.

19. The apparatus of claim 13 wherein the nomadic device is operative to initiate at least one of a request and view a picture of the entrance area of the building, unlock the entrance door, open the entrance door, close the entrance door, and lock the entrance door.

20. The apparatus of claim 13 further comprising authentication means for establishing authentication of at least one of a user of the nomadic device and a nomadic device before a command to the function control device is to be acted on.

21. The apparatus of claim 13 wherein the building is at least one of a home, an apartment, a garage, and an office building.

22. The apparatus of claim 13 wherein the input device is one of a doorbell switch and an intercom switch.

23. The apparatus of claim 13 wherein the audio communication between the nomadic device and the intercom at the building entrance is automatically muted while an instruction is being communicated from the nomadic device to the function control devices to perform at least one of unlock the door, open the door, close the door, lock the door, and sending a picture of the entrance area.

24. The apparatus of claim 13 wherein an instruction to the function control device will only be accepted while the intercom at the building entrance is at least one of off, muted, and temporarily deactivated.

25. The apparatus of claim 13 wherein a picture of the entrance area is automatically sent to the nomadic device when the input device is activated.

26. The apparatus of claim 13 wherein:
the nomadic device has modified software to communicate with the function control device.

27. The apparatus of claim 13 further comprising:
an intercom disposed at the building entrance operative to communicate audio between a person at the building entrance and the function control device.
